(19) United States
(12) Patent Application Publication
(10) Pub. No.: US 2025/0002621 A1
(43) Pub. Date: Jan. 2, 2025

(54) RESIN COMPOSITION

(71) Applicant: NAN YA PLASTICS CORPORATION, TAIPEI (TW)

(72) Inventors: Te-Chao Liao, TAIPEI (TW); Wei-Ru Huang, TAIPEI (TW); Hung-Yi Chang, TAIPEI (TW); Chia-Lin Liu, TAIPEI (TW)

(73) Assignee: NAN YA PLASTICS CORPORATION, TAIPEI (TW)

(21) Appl. No.: 18/448,962

(22) Filed: Aug. 13, 2023

(30) Foreign Application Priority Data
Jun. 28, 2023 (TW) 112124063

(51) Int. Cl. C08F 212/08; C08F 210/02; C08F 212/36; C08G 65/48; C08K 3/36; C08K 5/01; C08K 5/3415; C08L 53/02

(52) U.S. Cl. CPC C08F 212/08; C08F 210/02; C08F 212/36; C08G 65/485; C08K 3/36; C08K 5/01; C08K 5/3415; C08L 53/02; C08G 2650/04; C08L 2203/20; C08L 2205/03

(57) ABSTRACT

A resin composition includes a resin mixture. The resin mixture includes a first resin polymerized by a monomer mixture including styrene, divinylbenzene and ethylene; a second resin including polyphenylene ether resin modified by bismaleimide; a third resin block polymerized by a monomer mixture including styrene and butadiene; and an acenaphthylene.

### CROSS-REFERENCE TO RELATED APPLICATION

This application claims the priority benefit of Taiwan application serial no. 112124063, filed on Jun. 28, 2023. The entirety of the above-mentioned patent application is hereby incorporated by reference herein and made a part of this specification.

### BACKGROUND

### Technical Field

This disclosure relates to a composition, and in particular to a resin composition.

### Description of Related Art

In recent years, with the development of 5G communication, the materials of copper clad substrate have been developed with the goal of lowering dielectric properties. Currently, the dielectric constant of the copper clad substrates ranges from about 3.2 to 5.0, which is not favorable for high frequency and fast transmission applications in the future. Attempts have been made to reduce the dissipation factor of copper clad substrates by adding new low dielectric resins such as polystyrene resins to the resin composition. However, copper clad substrates made with these new low dielectric resins reduce the glass transition temperature while lowering the dissipation factor.

Based on the above, the development of a low dielectric resin composition with a low dielectric constant, a low dissipation factor, and a high glass transition temperature (Tg) is an urgent goal for those skilled in the art.

### SUMMARY

The disclosure provides a resin composition having a low dielectric constant, a low dissipation factor, a high glass transition temperature, and a low peeling strength change rate.

The resin composition of the disclosure includes a resin mixture. The resin mixture includes a first resin polymerized by a monomer mixture including styrene, divinylbenzene, and ethylene; a second resin including polyphenylene ether resin modified by bismaleimide; a third resin block polymerized by a monomer mixture including styrene and butadiene; and acenaphthylene.

In one embodiment of the disclosure, based on a total weight of the resin mixture, a content of the first resin is 10 wt % to 40 wt %, a content of the second resin is 30 wt % to 50 wt %, a content of the third resin is 10 wt % to 30 wt %, and a content of the acenaphthylene is 10 wt % to 30 wt %.

In one embodiment of the disclosure, a glass transition temperature of the resin composition is greater than 220° C.

In one embodiment of the disclosure, the resin composition has a reliability test peeling strength change rate of less than 10%.

In one embodiment of the disclosure, the monomer mixture of the first resin includes 10 mol % to 40 mol % of styrene, 10 mol % to 40 mol % of divinylbenzene, and 10 mol % to 20 mol % of ethylene.

In one embodiment of the disclosure, a number average molecular weight of the first resin is 4500 to 6500.

In one embodiment of the disclosure, the second resin is represented by the following chemical formula:

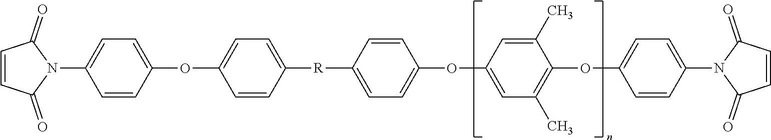

where R is a direct bond, a methylene group, an ethylene group, an isopropylene group, a 1-methylpropylene group, a sulfonylene group, or a fluorenylene group, and n is an integer between 3 and 25.

In one embodiment of the disclosure, the resin composition further includes a siloxane coupling agent, where based on 100 parts by weight of the resin mixture, the siloxane coupling agent is added in an amount of 0.1 parts by weight to 5 parts by weight.

In one embodiment of the disclosure, the resin composition further includes a flame retardant, where based on 100 parts by weight of the resin mixture, the flame retardant is added in an amount of 10 parts by weight to 50 parts by weight.

In one embodiment of the disclosure, the resin composition further includes spherical silicon dioxide, where a content of the spherical silicon dioxide is 30 wt % to 60 wt % of a sum of the spherical silicon dioxide, the flame retardant, and the resin mixture.

Based on the above, since the resin composition of the disclosure includes a first resin polymerized by a monomer mixture including styrene, divinylbenzene, and ethylene; polyphenylene ether resin modified by bismaleimide; a third resin block polymerized by a monomer mixture including styrene and butadiene; and acenaphthylene, a substrate made from the resin composition may achieve low dielectric constant, low dissipation factor, high glass transition temperature, and low peeling strength change rate, and thus enhance its reliability.

To make the aforementioned more comprehensive, several embodiments accompanied with drawings are described in detail as follows.

### DESCRIPTION OF THE EMBODIMENTS

Embodiments of the disclosure will be described in detail below. However, these embodiments are illustrative and the disclosure is not limited thereto.

In this disclosure, a range expressed from “one value to another” is a summary representation that avoids the need to list all the values in the range in the specification. Thus, the description of a particular range of values covers any value within that range of values and a smaller range of values defined by any value within that range of values, as if the arbitrary value and the smaller range of values are described in the specification.

The resin composition according to an embodiment of the disclosure includes a resin mixture. The resin mixture includes a first resin polymerized by a monomer mixture including styrene, divinylbenzene, and ethylene; a second resin including polyphenylene ether resin modified by bismaleimide; a third resin block polymerized by a monomer mixture including styrene and butadiene; and acenaphthylene. In some embodiments, the resin composition further includes a flame retardant, spherical silicon dioxide, a siloxane coupling agent, and/or other additives. The various components mentioned above will be described in detail below.

### Resin Mixture

In this embodiment, the resin mixture may include a first resin polymerized by a monomer mixture including styrene, divinylbenzene, and ethylene; a second resin including polyphenylene ether resin modified by bismaleimide; a third resin block polymerized by a monomer mixture including styrene and butadiene; and acenaphthylene.

### First Resin

In this embodiment, the first resin may be polymerized by a monomer mixture including styrene, divinylbenzene, and ethylene. In the monomer mixture, a molar ratio of styrene to divinylbenzene to ethylene may be from 1:1:1 to 2:2:1. For example, the monomer mixture of the first resin includes 10 mol % to 40 mol % of styrene, 10 mol % to 40 mol % of divinylbenzene, and 10 mol % to 20 mol % of ethylene. In some embodiments, a number average molecular weight of the first resin is 4500 to 6500.

In some embodiments, based on a total weight of the resin mixture, a content of the first resin may be 10 wt % to 40 wt %. Adding the first resin to the resin composition may help lower a dielectric constant of the resin composition.

### Second Resin

In this embodiment, the second resin may include polyphenylene ether resin modified by bismaleimide. For example, the second resin of the disclosure may be polyphenylene ether resin modified by bismaleimide disclosed in Taiwan Patent Publication No. 1774559, the disclosure of which is incorporated herein by reference in its entirety.

For example, a chemical structure of the polyphenylene ether resin modified by bismaleimide can be represented by the following chemical formula:

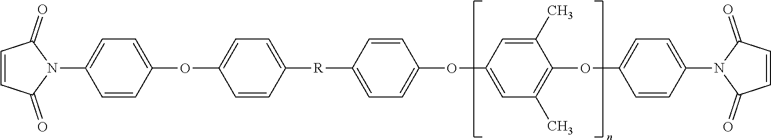

where R may be, for example: a direct bond, a methylene group, an ethylene group, an isopropylene group, a 1-methylpropylene group, a sulfonylene group, or a fluorenylene group, and n may be an integer between 3 and 25, preferably an integer between 10 and 18.

The polyphenylene ether resin modified by bismaleimide may be formed by the manufacturing method disclosed in Taiwan Patent Publication No. 1774559, but the disclosure is not limited thereto. The polyphenylene ether resin modified by bismaleimide may also be formed, for example, by other suitable modification methods.

In some embodiments, based on a total weight of the resin mixture, a content of the second resin is 30 wt % to 50 wt %. Since a chemical structure of the second resin has both a main chain of polyphenylene ether and an end modified by a highly heat-resistant reactive group (i.e., bismaleimide), the second resin has a relatively low dielectric constant and dielectric loss.

### Third Resin

In this embodiment, the third resin is block polymerized by a monomer mixture including styrene and butadiene. The third resin is, for example, a styrene-butadiene-styrene block copolymer (SBS). In some embodiments, the third resin may be polymerized by a monomer mixture including 5 mol % to 40 mol % of styrene, 55 mol % to 90 mol % of 1,2 butadiene, and 5 mol % to 30 mol % of 1,4 butadiene. In some embodiments, a number average molecular weight of the third resin may be 3500 to 5500.

In some embodiments, based on a total weight of the resin mixture, a content of the third resin may be 10 wt % to 30 wt %.

### Acenaphthylene

Acenaphthylene acts as a cross-linking agent in the resin mixture, and, due to its structural properties, improves the fluidity of the resin composition and increases the glass transition temperature. In some embodiments, based on a total weight of the resin mixture, a content of acenaphthylene may be 10 wt % to 30 wt %. When the content of acenaphthylene is below 10 wt %, the overall effect on resin mixture is not significant; when the content of acenaphthylene is above 30 wt %, the dielectric loss of the resin mixture will increase, which is not favorable for the application of high-frequency transmission substrates.

### Flame Retardant

In this embodiment, the flame retardant may be a phosphorus-containing flame retardant or a bromine-containing flame retardant. Specific examples of flame retardants may include, but are not limited to, Exolit OP 935 (available from Clariant), SPB-100 (available from Otsuka Chemical Co., Ltd.), PX-200 (available from Daihachi Chemical Co., Ltd.), PQ-60 (available from Jinyi Chemical).

In some embodiments, based on 100 parts by weight of the resin mixture, the flame retardant is added in an amount of 10 parts by weight to 50 parts by weight.

### Spherical Silicon Dioxide

In this embodiment, the spherical silicon dioxide may preferably using a synthetic method to reduce electrical properties and maintain fluidity and filler properties The spherical silicon dioxide may have the surface modification of acrylic or vinyl group, the purity is more than 99.0%, and an average particle size D50 is about 2.0 m to 3.0 m.

In some embodiments, a content of the spherical silicon dioxide is 30 wt % to 60 wt % of a sum of the spherical silicon dioxide, the flame retardant, and the resin mixture.

### Siloxane Coupling Agent

In this embodiment, the siloxane coupling agent may include but not limited to siloxane. In addition, depending on the type of functional group, it can be categorized as amino silane compound, epoxide silane compound, vinyl silane compound, ester silane compound, hydroxyl silane compound, isocyanate silane compound, methacryloxysilane compound, and acryloxysilane compound.

In some embodiments, based on 100 parts by weight of the resin mixture, the siloxane coupling agent is added in an amount of 0.1 parts by weight to 5 parts by weight. The siloxane coupling agent may enhance the compatibility and cross-linking degree of the resin composition for fiberglass cloth and powder.

### Other Additives

In addition to the above components, the resin composition of the disclosure may also contain other additives, such as initiators, leveling agents, antioxidants and etc. In some embodiments, the initiator may be a peroxide initiator.

In some embodiments, based on 100 parts by weight of the resin mixture, a content of the additive may be, for example, 0.1 parts by weight to 5 parts by weight, so as to realize the effect of the additive without affecting the overall dielectric properties and adhesion of the resin composition

It should be noted that the resin composition of the disclosure may be processed into a prepreg and/or copper clad laminate (CCL) depending on the actual design requirements. Therefore, the prepreg and the copper clad laminate made from the resin composition of the disclosure also have low dielectric constant, low dissipation factor, high glass transition temperature, and good adhesion characteristics, which in turn have better reliability. In more detail, the dielectric constant of the prepreg and the copper clad laminate made by the resin composition may be about 3.0 to 3.1, the dissipation factor may be about 0.0015 or less than 0.0015, and may have a glass transition temperature of more than 220 degrees, for example, about 220 degrees to about 270 degrees, and a reliability test peeling strength change rate of less than 10%, to flexibly adapt to changes in the environment and improve reliability.

Hereinafter, the resin composition of the disclosure is described in detail by means of experimental examples. However, the following experimental examples are not intended to limit the disclosure.

### Preparation Example: Preparation of the Second Resin

Polyphenylene ether resin material of small molecular weight with a number average molecular weight (Mn) less than or equal to 12,000 or less than or equal to 10,000 (e.g., Mn=500, 1400, 1600, or 1800) was dissolved in dimethyl acetamide, and then potassium carbonate and tetrafluoronitrobenzene were added. The above reaction solution was heated to 140° C. and reacted for 8 hours and then cooled down to room temperature, followed by filtration to remove the solids. Methanol/water is used to precipitate the filtrate, and the precipitate is nitrified polyphenylene ether resin. Then the nitrified polyphenylene ether resin was dissolved in dimethyl acetamide and hydrogenated at 90° C. for 8 hours to obtain aminated polyphenylene ether resin. Then the aminated polyphenylene ether resin is placed in toluene, and maleic anhydride and p-toluenesulfonic acid are added, and the temperature is raised to 120 degrees to reflux, and the reaction is carried out for 8 hours, then the second resin may be produced. The second resin is polyphenylene ether resin modified by bismaleimide (PPE-BMI).

### Examples 1 to 3 and Comparative Example 1

Examples 1 to 3 and Comparative Example 1 are varnish that use toluene to form a thermosetting resin composition according to the resin composition shown in Table 1. The varnish was impregnated with NAN YA fiberglass cloth (manufactured by NAN YA PLASTICS CORPORATION, cloth type: 1078LD) at room temperature. Then, after drying at 170° C. (impregnator) for several minutes, a prepreg with a resin content of 79 wt % was obtained. Finally, 4 pieces of prepreg were stacked layer by layer between two pieces of 35 m thick copper foil, at the pressure of 25 kg/cm² and the temperature of 85° C., and kept the constant temperature for 20 minutes; then heated at 3° C./min until 210° C., and kept the constant temperature for 120 minutes. Next, after cooling slowly to 130° C., a 0.59 mm thick copper clad substrate was obtained.

In Table 1, the details of each component are as follows:
first resin: purchased from Denka Company, model: LDM;
second resin: use the second resin of the preparation example;
third resin: purchased from Nippon Soda Co., Ltd., model: 1,2-SBS Type-C;
acenaphthylene: purchased from JFE Chemical Corporation;
spherical silicon dioxide: purchased from Sanshiji Company, model: EQ2410-SMC;
flame retardant: purchased from Jinyi Chemical Industries Co., Ltd., model: PQ-60;
siloxane coupling agent: purchased from Dow Corning, model: Z-6030; and
initiator: purchased from ARKEMA Company, model: Luperox F

### Evaluation Method

The copper clad substrates produced in each example and comparative example were evaluated according to the following method, and the results of the evaluation are recorded in Table 1.

The glass transition temperature (° C.) was tested with a dynamic mechanical analyzer (DMA).

Water absorption (%): a sample is heated at 120° C. and 2 atm in a pressure cooker for 120 minutes and then a weight change before and after heating is calculated.

Heat resistance (seconds): the sample was heated in a 120° C. and 2 atm in a pressure cooker for 120 minutes, then immersed in a 288° C. solder furnace, and the time required for the sample to burst and delaminate was recorded. When the immersion tin time was more than 10 minutes without delamination, it was rated as OK; when the immersion tin time was less than 10 minutes and delamination, it was rated as not OK.

### Reliability Test-Peeling Strength Test:

A copper clad laminate (formed by 4 sheets of semi-cured sheet pressed together) was cut into a rectangular sample with a width of 30 mm and a length of more than 50 mm, and the surface of the copper clad laminate was etched, leaving only a long strip of copper foil with a width of 3 mm and a length of more than 50 mm, and a universal testing tensile machine was utilized to measure an amount of force (F1) required to initially pull the copper foil away from the surface of an insulating layer of the substrate and an amount of force (F2) required to pull the copper foil away from the surface of the insulating layer of the substrate after 1000 hours at 85° C. and 85% relative humidity. Then the strength change rate is calculated by (F2-F1)/F1*100%.
Dielectric constant Dk: the dielectric constant Dk at 10 GHz was measured by Dielectric Analyzer HP Agilent E4991A.
Dissipation factor Df: the dissipation factor Df at 10 GHz was measured by Dielectric Analyzer HP Agilent E4991A.
Resin flow rate: the resin is pressed at 170° C. plus or minus 2.8° C. in a press with 200 plus or minus 25 PSI for 10 minutes, fused and cooled down, then a disc was punched out, and the weight of the disc was weighed precisely to calculate an amount of resin flow.

### Resin Phase Separation (Slice Analysis):

Step 1: the copper clad laminate was cut into 1 cm*1 cm size and put into a mold for resin grouting.
Step 2: after the resin has dried and hardened completely, the sample is ground and polished.
Step 3: the sample was analyzed by high resolution microscope, such as OM/SEM, to confirm whether there is resin phase separation inside the sample.

TABLE 1

| | | | Comparative | | | |
|---|---|---|---|---|---|---|
| | | | Example 1 | Example 1 | Example 2 | Example 3 |
| resin | resin | first resin | 40 | 30 | 20 | 10 |
| composition | mixture | (parts by weight) | | | | |
| | | second resin | 40 | 40 | 40 | 40 |
| | | (parts by weight) | | | | |
| | | third resin | 20 | 20 | 20 | 20 |
| | | (parts by weight) | | | | |
| | | Acenaphthylene | — | 10 | 20 | 30 |
| | | (parts by weight) | | | | |

| | spherical silicon dioxide | 86.67 | 86.67 | 86.67 | 86.67 |
|---|---|---|---|---|---|
| | (parts by weight) | | | | |
| | flame retardant (parts by | 30 | 30 | 30 | 30 |
| | weight) | | | | |
| | Initiator (parts by weight) | 1 | 1 | 1 | 1 |
| | siloxane coupling | 0.5 | 0.5 | 0.5 | 0.5 |
| | agent(parts by weight) | | | | |
| B-stage curing temperature (° C.) | | 130 | 130 | 130 | 130 |
| glass transition temperature (° C.) | | 200 | 226 | 252 | 261 |
| water absorption (PCT 1/2 hour) (%) | | 0.22 | 0.22 | 0.21 | 0.21 |
| heat resistance (PCT 1/2 hour) | | OK | OK | OK | OK |
| water absorption (PCT 2 hour) (%) | | 0.29 | 0.28 | 0.26 | 0.26 |
| heat resistance (PCT 2 hour) | | OK | OK | OK | OK |
| peeling | initial value (lb/in) | 4.02 | 4.01 | 4.00 | 3.98 |
| strength test | after 1000 hours at 85° C. | 3.56 | 3.68 | 3.72 | 3.89 |
| | and 85% relative humidity | | | | |
| | (lb/in) | | | | |
| | change rate (%) | 11.4 | 8.2 | 7 | 2.2 |

| dielectric constant (Dk) | 3.07 | 3.08 | 3.09 | 3.09 |
|---|---|---|---|---|
| (measurement frequency 10 GHz) | | | | |
| dissipation factor (Df) | 0.00148 | 0.00146 | 0.00145 | 0.00149 |
| (measurement frequency 10 GHz) | | | | |
| resin flow rate (%) | 35 | 36 | 39 | 41 |
| resin phase separation (slice analysis) | no phase | no phase | no phase | no phase |
| | separation | separation | separation | separation |

As can be seen from Table 1, Examples 1 to 3, in which acenaphthylene is included in the resin composition, have higher glass transition temperatures and maintain low dielectric properties (e.g., low dielectric constants, low dissipation factors) at high frequencies compared to Comparative Example 1, in which no acenaphthylene is added to the resin composition. In addition, Examples 1 to 3 have better adhesion than Comparative Example 1 after 1000 hours at 85° C. and 85% relative humidity. It can be seen that Examples 1 to 3 exhibit good reliability and are suitable for application in high frequency transmission substrates.

In summary, since the resin composition of the disclosure includes a first resin polymerized by a monomer mixture including styrene, divinylbenzene, and ethylene; polyphenylene ether resin modified by bismaleimide; a third resin block polymerized by a monomer mixture including styrene and butadiene; and acenaphthylene, a substrate made from the resin composition may achieve low dielectric constant, low dissipation factor, high glass transition temperature, and low peeling strength change rate, and thus enhance its reliability.

It will be apparent to those skilled in the art that various modifications and variations can be made to the disclosed embodiments without departing from the scope or spirit of the disclosure. In view of the forthcoming, it is intended that the disclosure covers modifications and variations provided that they fall within the scope of the following claims and their equivalents.

What is claimed is:

1. A resin composition comprising:
a resin mixture comprising:
a first resin polymerized by a monomer mixture comprising styrene, divinylbenzene, and ethylene;
a second resin comprising polyphenylene ether resin modified by bismaleimide;
a third resin block polymerized by a monomer mixture comprising styrene and butadiene; and
acenaphthylene.

2. The resin composition according to claim 1, wherein based on a total weight of the resin mixture, a content of the first resin is 10 wt % to 40 wt %, a content of the second resin is 30 wt % to 50 wt %, a content of the third resin is 10 wt % to 30 wt %, and a content of the acenaphthylene is 10 wt % to 30 wt %.

3. The resin composition according to claim 1, wherein a glass transition temperature of the resin composition is greater than 220° C.

4. The resin composition according to claim 1, wherein the resin composition has a reliability test peeling strength change rate of less than 10%.

5. The resin composition according to claim 1, wherein the monomer mixture of the first resin comprises 10 mol % to 40 mol % of styrene, 10 mol % to 40 mol % of divinylbenzene, and 10 mol % to 20 mol % of ethylene.

6. The resin composition according to claim 1, wherein a number average molecular weight of the first resin is 4500 to 6500.

7. The resin composition according to claim 1, wherein the second resin is represented by following chemical formula: 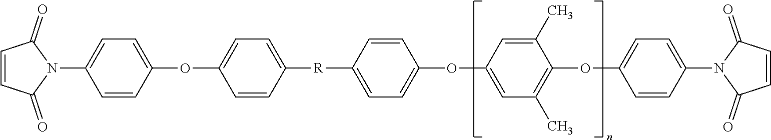
where R is a direct bond, a methylene group, an ethylene group, an isopropylene group, a 1-methylpropylene group, a sulfonylene group, or a fluorenylene group, and n is an integer between 3 and 25.

8. The resin composition according to claim 1 further comprising a siloxane coupling agent, wherein based on 100 parts by weight of the resin mixture, the siloxane coupling agent is added in an amount of 0.1 parts by weight to 5 parts by weight.

9. The resin composition according to claim 1 further comprising a flame retardant, wherein based on 100 parts by weight of the resin mixture, the flame retardant is added in an amount of 10 parts by weight to 50 parts by weight.

10. The resin composition according to claim 9 further comprising spherical silicon dioxide, wherein a content of the spherical silicon dioxide is 30 wt % to 60 wt % of a sum of the spherical silicon dioxide, the flame retardant, and the resin mixture.
